(19) United States
(12) Patent Application Publication
(10) Pub. No.: US 2015/0280435 A1
(43) Pub. Date: Oct. 1, 2015

(54) GENERATOR EFFICIENCY WITH AN ANCILLARY SERVICES NETWORK

(71) Applicant: ENBALA POWER NETWORKS INC., North Vancouver (CA)

(72) Inventors: Malcolm Stuart Metcalfe, Penticton (CA); Andrew Ross Gassner, Garibaldi Highlands (CA)

(73) Assignee: Enabla Power Networks Inc., North Vancouver, BC (CA)

(21) Appl. No.: 14/428,931

(22) PCT Filed: Sep. 18, 2013
(86) PCT No.: PCT/CA2013/050715

§ 371 Date: Mar. 17, 2015

Related U.S. Application Data
(60) Provisional application No. 61/703,075, filed on Sep. 19, 2012.

(51) Int. Cl. H02J 3/14; G05B 15/02; G06Q 50/06

(52) U.S. Cl. CPC H02J 3/14; G06Q 50/06; G05B 15/02

(57) ABSTRACT

A method for providing automatic generation control (AGC) services comprises: allocating at least one generator resource and at least one load resource to provide AGC services; and responding to at least part of an AGC services request using the load resource such that the generation resource responds to the rest of the AGC services request by operating at an operating set point that is more efficient than a set point required for the generation resource to respond fully to the AGC services request. The step of responding can comprise executing a cost function that compares costs of using the load and generation resources to respond to the AGC services request at different load and generation set points and selecting a combination of load and generation set points that meets a cost effectiveness threshold.

### FIELD OF INVENTION

This invention relates generally to a method and apparatus for improving efficiency of an electric power system generator in a vertically integrated utility (VIU) or independent system operator (ISO) network using an ancillary services network.

### BACKGROUND

Electricity is a currency for energy. It provides a convenient and safe means of delivering energy from sources, including heat from burning coal or nuclear fission, falling water, solar or wind power to users. Because electricity cannot easily be stored, generation (supply) and load (demand) must be maintained in a continuous balance. For more than 100 years, vertically integrated electric utilities (“VIUs”) have maintained this balance by continuously adjusting generation sources to match the total system demand. The utilities generally concluded that generation could be controlled easily, while loads could not.

Utilities face a number of key operational issues, one of which is system regulation. Also known as automatic generation control (AGC), system regulation is a process which measures the difference between supply and demand on a second by second basis, sending signals to specific generation sources every few seconds to maintain the exact balance. Traditionally, utilities have used dedicated generators for this role, selecting machines that have fast response and a range of operation that allows the AGC to be effective. The generators used for AGC provide a service known as system regulation service, or just “regulation service”. This service can bought by the VIU, or by an ISO in a deregulated electricity market, from third party regulation services providers.

When purchasing regulation services, the ISO or VIU may send regulation services request signals to regulation service providers requesting a change in power to the grid in order to maintain the system balance. These signals may come every few seconds. The regulation service provider will react to the request, and send signals back to the ISO or VIU showing the change achieved.

Historically, before the use of automatic control equipment, a single electrical generator unit was used as the regulating device and its power output would be adjusted up and down in order to balance the generation and load of the system. With the advance of computational and communication technologies, AGC was developed to coordinate multiple generator units to participate in balancing the system and thereby reducing the wear and tear on the single unit as well as improving the overall system efficiency.

Traditionally, AGC systems have used electrical power generators to increase or decrease power generation to reduce the mismatch between electrical generation and demand within their control areas, referred to as the Area Control Error (ACE). However, use of generators in such a manner typically results in the generators operating in a less than optimally efficient manner. Electrical generating equipment is designed for a specific rated power output. The most efficient operational set point of the generator is typically somewhere between 80% and 100% of the rated output. Any deviation from this optimal set point results in degraded performance causing higher production costs and, in the case of fossil fuel systems, higher greenhouse gas emissions. When generators are used to provide regulation services via automatic generation control, the AGC system sends a control signal to the generators, instructing them increase or decrease power production depending on the balancing needs of the power system. For generators to provide regulation services, they are required to reserve capacity so that they can increase and decrease generation as needed. This reserved capacity requires the generators to be dispatched at suboptimal power set points thereby incurring efficiency penalties.

### SUMMARY OF THE INVENTION

According to one aspect of the invention, there is provide a method for providing automatic generation control (AGC) services comprising: allocating at least one generator resource and at least one load resource to provide AGC services; and responding to at least part of an AGC services request using the load resource such that the generation resource responds to the rest of the AGC services request by operating at an operating set point that is more efficient than a set point required for the generation resource to respond fully to the AGC services request. The step of responding can comprise executing a cost function that compares costs of using the load and generation resources to respond to the AGC services request at different load and generation set points and selecting a combination of load and generation set points that meets a cost effectiveness threshold.

Each load resource can comprise an allocated state of charge range and an allocated AGC services range, in which case the allocated load resources operate at an operating set point within the allocated AGC services range and has a state of charge within the allocated state of charge range. Also, each generation resource can comprise an allocated AGC services range with a base set point that is different than an optimally efficient set point of the generation resource, in which case the operating set points of the allocated generation resources are within the allocated AGC services range.

The costs of using the generation resource can be a function of an efficiency profile of the generator resource. Similarly, the costs of using the load resource can be a function of an efficiency profile of the load resource. Also, the costs of using the load resources can be a function of a state of charge profile of the load resource. The cost of using the generation resource can be specified to be always higher than the cost of using the load resource when the generation resource operating set point is less than the optimally efficient set point of the generation resource. Similarly, the cost of using the load resource can be specified to be always higher than the cost of using the generation resource when the state of charge of the load resource is at a maximum or minimum value in the allocated state of charge range.

According to another aspect of the invention there is provided a system for providing automatic generation control (AGC) services comprising: a processor communicative with at least one load resource and at least one generation resource to send set point control signals thereto and with a controller of a vertical integrated utility to receive an AGC services request signal therefrom; a memory having encoded thereon instructions executable by the processor to carry out the method described above using the AGC request signal received by the processor. The processor can be communicative with the at least one load resource and at least one generation resource to receive at least one of generator state information, load state information, generator efficiency profile, and load efficiency profile.

### BRIEF DESCRIPTION OF FIGURES

FIG. 1 is a block diagram of an embodiment of an apparatus for providing ancillary and generator optimization services to a VIU or an ISO using a network of load resources and generation resources.

FIG. 2 is a block diagram illustrating inputs to and outputs from an ancillary services controller of the apparatus, that is encoded with an ancillary services program having a generator efficiency optimization program module.

FIG. 3 is a chart showing an example of a generation resource efficiency curve that is an input for the ancillary services controller.

FIG. 4 is a chart showing an example of an AGC control signal that is an input for the ancillary services controller shown.

FIG. 5 is a flow chart illustrating steps of the generator efficiency optimization program module that are executed by the ancillary services controller to improve generator efficiency when providing regulation services.

FIG. 6 is a graph showing the output of generation and load resources dispatched by the controller in response to the AGC request signal, wherein the controller executes the generator efficiency optimization program module having a cost function according to one embodiment.

FIG. 7 is a graph showing the output of generation and load resources dispatched by the controller in response to the AGC request signal, wherein the controller executes the generator efficiency optimization program module having a cost function according to another embodiment.

FIG. 8 is a flow chart illustrating the operational logic of the generator efficiency optimization program module in the embodiment shown in FIG. 6.

FIGS. 9(a) and (b) are flow charts illustrating the operational logic of the generator efficiency optimization program module in the embodiment shown in FIG. 7.

### DETAILED DESCRIPTION

The embodiments described herein relate generally to a method and system for improving the efficiency of an electrical generator providing AGC services by using an ancillary services network that includes load resources. More particularly, the embodiments relate to a method and system for responding to at least part of an AGC services request using the load resources such that the generator responds to the rest of the AGC services request by operating at an operating set point that is more efficient than a set point required for the generator to respond entirely to the AGC services request.

Throughout the disclosure where a server or controller is referenced it may include one or more servers or controllers in communication with each other through one or more networks or communication mediums. Each server and controller generally comprises one or more processors and one or more computer readable mediums in communication with each other through one or more networks or communication mediums. The one or more processors may comprise any suitable processing device known in the art, such as, for example, application specific circuits, programmable logic controllers, field programmable gate arrays, microcontrollers, microprocessors, virtual machines, and electronic circuits. The one or more computer readable mediums may comprise any suitable memory devices known in the art, such as, for example, random access memory, flash memory, read only memory, hard disc drives, optical drives and optical drive media, or flash drives. In addition, where a network is referenced it may include one or more suitable networks known in the art, such as, for example, local area networks, wide area networks, intranets, and the Internet. Further, where a communication to a device or a direction of a device is referenced it may be communicated over any suitable electronic communication medium and in any suitable format known to in the art, such as, for example, wired or wireless mediums, compressed or uncompressed formats, encrypted or unencrypted formats.

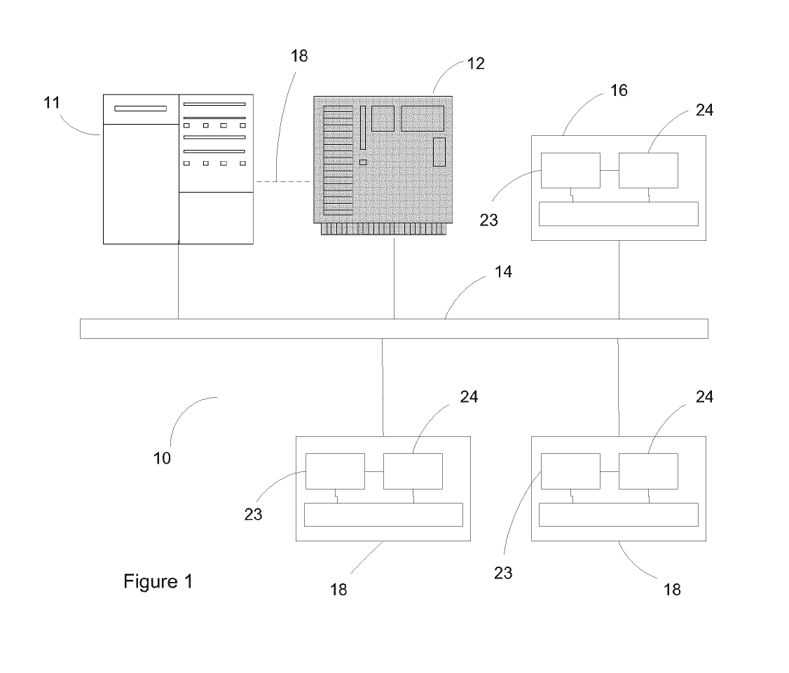

In the embodiments described herein and referring to FIG. 1, an apparatus 10 for providing system regulation and other ancillary services to a VIU 11 (or an ISO) comprises an ancillary services controller 12 that is communicative over a first network 18 with the VIU 11 and over a second network 14 with multiple resource devices (alternatively referred to as “devices” or “resources”) within the VIU (or ISO) operating area. The ancillary services controller 12 is programmed to control the resources to provide regulation and other ancillary services (otherwise known as “AGC services”) requested by the VIU 11. The resources are typically located at sites remote from the ancillary services controller 12 (“resource sites”) and include at least one electrical generator 16 that has been assigned to provide AGC services (“AGC generator” or “generation resource”), as well as at least one electrically-powered device having capacity to consume a load (“load resource”) 18. The apparatus 10 can control one or multiple generation resources 16 and load resources 18 to provide AGC services; in this description, reference to a singular resource shall be construed to mean one or more resources.

In this embodiment, the apparatus 10 provides AGC services that try to use the generator 16 as efficiently as possible; the generator 16 which efficiency is being optimized is typically owned or controlled by the VIU 11 and thus the VIU 11 would directly benefit from more efficient use of its generators. Alternatively, the apparatus 10 can also be configured to provide ancillary services to an ISO, in which case the generator owner/operator of the generator (who may be different than the ISO) would benefit from the improved operating efficiency of the generators.

System regulation and other ancillary services provided by the apparatus 10 are described in Applicant's own PCT application WO 2011/085477 entitled “Ancillary Services Network Apparatus”, which is incorporated by reference. This description will thus focus on the generator efficiency optimization aspects of providing ancillary services by the apparatus 10.

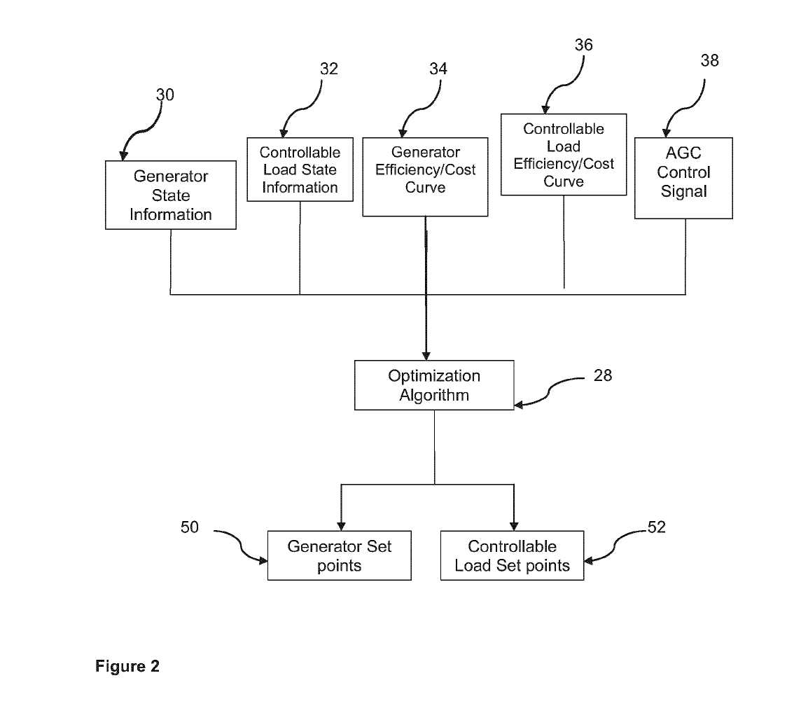

In a conventional operation, the VIU 11 utilizes some or all of its own generators to provide dispatch services (“dispatch generators”), and some or all of its own generators to provide AGC (“AGC generators”). The VIU 11 typically forecasts the energy needed for the next time interval (e.g. next hour) and provides scheduling instructions for all of its dispatch generators to provide the forecasted energy demand. The VIU 11 typically has a controller (“VIU controller”) which processes an ACE signal, which calculates the error between the forecasted energy and real-time demand, and then provides AGC generators with a real-time control signal to provide regulation services in response to the ACE. In this embodiment and in contrast to the conventional approach, the ancillary services controller 12 of the apparatus 10 is operationally interposed between with the VIU controller and its AGC generator(s) 16 such that the ancillary services controller 12 controls these AGC generator(s) 16 directly. Therefore, the VIU 11 will no longer send control signals to the AGC generator(s) 16; instead, the VIU 11 will send an AGC request signal to the ancillary services controller 12, which will then execute a generator efficiency optimization program module 28 (see FIG. 2) that determines a schedule for operating the AGC generator(s) 16 and load resource(s) 18 to provide regulation services in a manner that allows the AGC generator(s) 16 to operate in a more efficient state than in the conventional operation.

As noted above, generators that are conventionally used to provide regulation services will typically not be able to operate consistently at their optimally efficient set points, since conventionally operated AGC generators will need to reserve capacity so they can increase and decrease generation as needed. In contrast to generators, certain load resources when used to provide regulation services have minimal to no impact on their efficiency. For example, load resources that are binary in their function (are limited to an on or off state) can be coordinated such that the timing of consumption is changed from their normal operation, but the operational efficiency and the total energy consumed remains unchanged. As will be described in more detail below, the ancillary services controller 12 is programmed to operate the resources 16, 18 in a manner that enables the generator resource 16 to run in a more efficient manner than when the generator 16 is conventionally deployed to provide regulation services. More particularly, the ancillary services controller 12 is programmed with a generator efficiency optimization program module 28 which calculates in real time an allocation of the AGC signal to the load resource 18 and the generator resource 16 such that the generator efficiency is improved.

In this embodiment, the load resource 18 can for example be a multiple single-speed water pump, an analog electrical boiler, and an analog electrical blower. These electrically-powered devices 18 are normally intended to serve a primary process other than providing regulation services for the VIU 11, and the apparatus 10 is configured to operate one or more of these devices as a load resource 16 to provide regulation services only within the operational constraints defined by the primary processes of these devices 18. For example, the water pump can be used primarily to regulate the water level in a municipal water supply tank, each electrical boiler can be used primarily to provide heat and domestic hot water for a building as part of a hybrid electric-gas heating system, and each blower can be used primarily to aerate a waste water treatment tank.

In an alternative embodiment, the load resource 18 can be dedicated to provide ancillary services for the apparatus 10. In other words, such load resources 18 are not utilized to provide a primary service and instead are dedicated to provide only ancillary services. In yet another alternative embodiment, the apparatus 10 comprises a combination of load resources 18 dedicated to provide ancillary services and load resources 18 that provide both a primary service and ancillary services.

The apparatus 10 comprises one or more local resource controllers 24 that are communicative with the controllable generation and load resources 16, 18 and with the ancillary services controller 12. Each local resource controller 24 is programmed to receive control signals from the ancillary services controller 12 comprising an operational set point for each resource 16, 18; the local resource controller is programmed to operate each resource 16, 18 at these set points to provide the required regulation and other ancillary services.

When controlling load resources 18 that serve a primary service in addition to ancillary services, the local resource controller 24 is further programmed to only operate the load resource 18 when the set point is within the operational constraints of the load resource 18. For certain load resources 18, a “state of charge” value can be calculated to indicate how close a load resource 18 is to its operational constraints; when the load resource's state of charge reaches a minimum or maximum value, the load resource 18 must be taken off-line from providing system regulation and generator optimization services. For example, a municipal water plant operator may require that a water tank be kept between 10% and 90% full of water, and the services controller 24 is programmed to allow the ancillary services controller 12 to operate the pump for this tank while the water level is within this range. However, when the water level in the tank rises to 90% full (maximum state of charge), a local device controller 23 will turn the pump on, even if the ancillary services controller 12 desires the pump to be kept off. Controllable resources 16 which are at their operational limits due to constraints with their primary process are considered to be “off-line” to the ancillary services controller 12 and not available to provide system regulation and other ancillary services; conversely, controllable resources 16 whose devices are within their primary operational constraints are considered “on-line” and available to be used to provide system regulation and other ancillary services. The apparatus 10 is provided with a sufficient number of generation and load resources 16, 18 that there is always enough resources 16, 18 to respond to the AGC request signal 22; optionally, the apparatus 10 can be provided with a sufficient number of load resources 18 that there is always enough “on-line” load resources at any given time to provide regulation and other ancillary services.

The ancillary services controller 12 can be part of a computer hardware system that is spread across multiple hardware chassis either to aggregate sufficient processing capability, or to provide redundancy in the event of failure, or both. One chassis can operate as the primary ancillary services controller 12, and another as a backup ancillary services controller 12. Each chassis can run a multi-core capable operating system. The ancillary services controller 12 can be located on a premise where both generators 16 and load resources 18 exist, and in particular, can be physically located beside or in close physical proximity to a central control room of the VIU 11 or other electrical system operator (e.g. an ISO) and be connected to the VIU computer system by a dedicated communications link 18, such as Frame Relay. Where one or more resources are remotely located, the controller 12 can alternatively be located at a remote server with those remotely located resources.

The ancillary services controller 12 has a memory on which is stored an ancillary services program with a generator efficiency optimization program module 28 which is executed by the ancillary services controller 12 to try to improve generator efficiency when providing ancillary services. The ancillary services program can also include a system regulation program module such as that disclosed in PCT application WO 2011/085477, which is executable by the ancillary services controller 12 to provide regulation services.

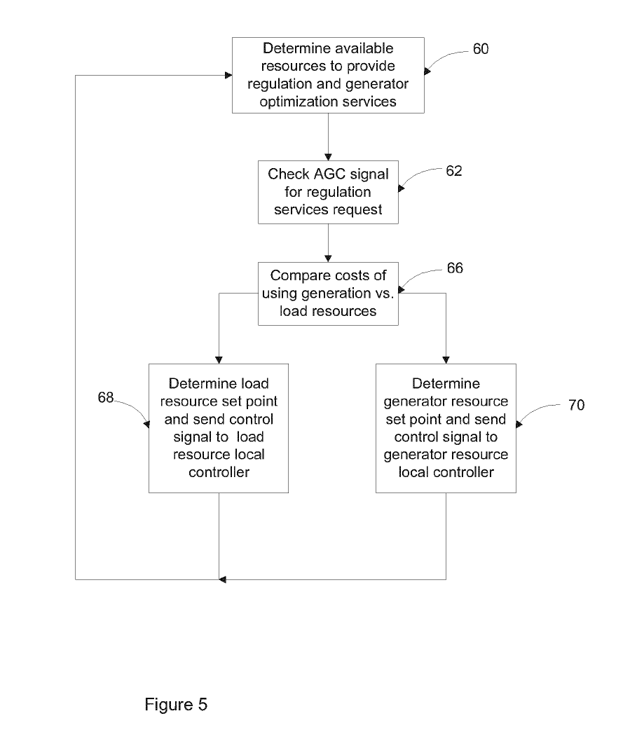

The generator efficiency optimization program module 28 is described in detail below with reference to FIG. 5, and includes instructions that when executed, examines all of the resources 16, 18 that are communicative with the ancillary services controller 12 and selects a cost-effective means of achieving the target level or adjustment specified by the AGC request signal 22. The generator efficiency optimization program module 28 includes a cost comparison function which compares the relative cost of operating the generator 16 at a less-than-optimal efficiency to provide regulation services versus the cost of operating the load resource 18 to provide some or all of those services. The ancillary services program then selects the resource 16, 18 which provides the regulation service in the most cost-efficient manner. The system regulation and generator efficiency optimization program modules can cooperate in a layered manner, wherein the generator efficiency optimization program module performs a first optimization to see whether a load or generator should be deployed to respond to an AGC request signal; then, the system regulation program module can be executed to determine the manner which loads are to be used.

Referring now to FIG. 2, the ancillary services controller 12 is communicative with the generator and load resources 16, 18 and receives the following information from these resources 16, 18 for use as inputs by the ancillary services program: current state information of each generator resource 30, current state information of each load resource 32, efficiency/cost curve for each generator resource 34, efficiency/cost curve for each load resource 36. The ancillary services controller 12 is also communicative with the VIU controller and receives the AGC request signal 22 as an input to the ancillary services program.

The current state information of the generator and load resources 30, 32 provide information to the optimization program module about the availability of each generator and load resource 16, 18 to provide regulation services. The current state information of each generator 16 includes: the current generator power output, maximum and minimum power output, availability flag, and any operational constraints due to local generator conditions. The current state information of each load 18 includes: the current power consumption of the load, the load's present state of charge, availability flag, and any operational constraints due to local site/load conditions including an acceptable state of charge range.

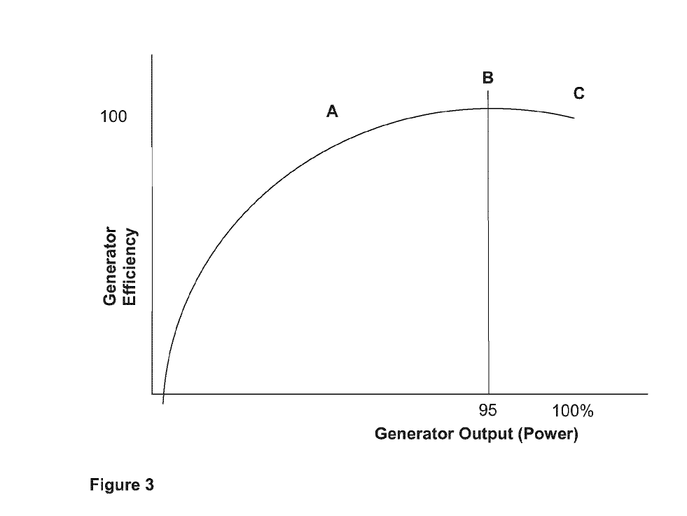

Referring to FIG. 3, the cost-efficiency curve for each generator 16 provides information about the efficiency of the generator 16 at a particular power output. FIG. 3 provides an example of a generator where the optimally efficient set point is at a generator output of 95% (Point B); any deviation from this set point will result in sub-optimal efficiency and the optimization program module ascribes an operating cost for each set-point on this curve. The optimization program module will also determine a base set point and an operating range around this set point that is reserved for providing regulation services. For example, the generator 16 can be set (or “dispatched”) to Region A in order to leave enough reserve capacity to increase power production when requested by the AGC control signal. As the generator follows the AGC control signal it will move up and down its efficiency curve, and the optimization program module will determine the operating cost of the generator at each set point along this efficiency curve, with the lowest operating cost being at point B.

Although not shown, some load resources also have an efficiency curve. The nature of the efficiency curve will depend on the type of load being used as a load resource. For those load resources that do have an efficiency curve, the optimization program module 28 can ascribe an operating cost for each set point along the curve. The optimization program module can also determine a base set point and the operating range around this set point that is allocated to provide regulation services. The optimization program module 28 can also ascribe a cost for operating a load resource at a given state of charge; the ascribed cost will depend on type of load, and the severity of operating the load near or at its operational constraint. To discourage the ancillary services program from running a load to its maximum or minimum state of charge, the optimization program module 28 can ascribe an increasing cost to the state of charge as it approaches the maximum and minimum operational constraints; as will be discussed below, the optimization program module 28 will execute a cost comparison step to determine relative costs of using the generation resource 16 and the load resource 18 to provide regulation services; when the load resource is close to or at its maximum or minimum state of charge, the relative costs should favour selecting the generation resource 16 to provide the requested services.

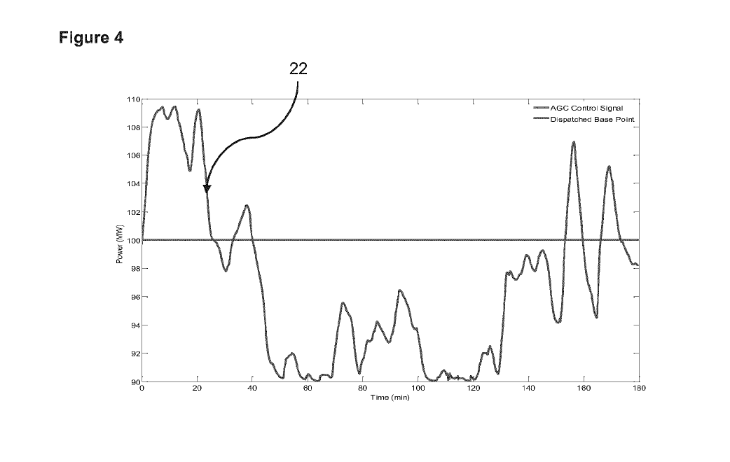

Referring to FIG. 4, the AGC request signal 22 represents a request from the VIU 11 to the apparatus 10 to provide a change in electrical power delivered to (or from) the VIU 11 within a certain period of time. The request signal 22 is typically updated frequently, typically about every four seconds. A typical AGC request includes a target power set point, although in some cases, the AGC request can also include a target set point completion time, an energy price, and a regulation price. The target set point may be either a change in the operating point power for the network, or an absolute operating point power for the network. The target set point completion time is the amount of time the ancillary services controller 12 has to achieve the target set point; the energy price is the wholesale price of electricity at the time the AGC request is made, and may be used by cost functions in determining the financial cost of operating a resource at an particular set point, as will be explained in more detail below. The regulation price is the monetary amount the VIU 11 will pay the regular services provided for providing the requested services, and may also be used by cost functions. The generator efficiency optimization program module does not need to use the target set point completion time, energy price and regulation price in this embodiment; however, such information can be used in other embodiments to provide further control or optimization of resources.

Referring now to FIG. 5, the generator efficiency optimization program module 28 comprises a series of steps that are executable by the ancillary services controller 12 to determine the generator and load control set points for a given set of inputs.

The generator efficiency optimization program module 28 first determines the available (on-line) resources 16, 18 to provide regulation services (step 60) by checking the current power output and corresponding efficiency of each generator 16 and load 18 on control. Available generator resources 16 are those operating at an acceptable power output and efficiency and within their allocated regulation services range. Similarly, available load resources are those operating at an acceptable load consumption and efficiency and within their allocated state of charge range and allocated regulation services range.

The optimization program module 28 then checks for an AGC signal 22 requesting regulation services (step 62). The optimization program module 28 records the target set point (in MW) and the target set point completion time from the AGC signal 22 then calculates the change in power consumption that would be required from the load resource 18 and the change in power generation that would be required from the generation resource 16 to achieve the target set point within the target set point completion time. An increase in regulation response can be provided by increasing power generation of the generator 16 or decreasing the power consumption of the load 18, and conversely a decreased regulation response can be provided by decreasing the power generation of the generator 16 or increasing the power consumption of the load 18.

The optimization program module then executes a cost comparison (step 66) to determine which combination of changes in load resource consumption and generator resource production that will be most cost effective to respond to the regulation services request.

The cost of the load resources 18 and generation resource 16 is determined using the generator state information, load state information (including state of charge information), generator efficiency curve, and load efficiency curve (when applicable) in a manner as discussed above. In one embodiment, the cost comparison step determines the cost of using the generator resource 16 given its current operational set point, and determines the cost of using the load resource given its current operational set point and state of charge. As noted above, the optimization program module 28 can ascribe an increasingly higher cost to use a load resource when it approaches its maximum or minimum state of charge. Similarly, the optimization program module 28 can ascribe an increasingly higher cost when the load resource or the generation resource approaches one of the boundaries of their regulation services range. Once a resource reaches one of the limits of its regulation services range, it can no longer provide additional regulation services, and the optimization program module 28 can ascribe an infinitely high cost to use the resource at such limits, such that the cost comparison step will select the other resource to respond to the AGC request.

When the cost comparison step determines it is cost effective to use the load resource to provide the regulation response, the optimization program module 28 determines the appropriate set point for the load resource 18 to provide the required regulation response and then instructs the ancillary services controller 12 to send the determined set point to the local resource controller 24 of the load resource 18 (step 68).

When the cost comparison step determines that it cost effective to use the generator resource 16, the optimization program module 28 determines the appropriate generator set point that will cause the generator resource 16 to provide the required regulation response. Then, the optimization program module 28 instructs the ancillary services controller 12 to send the determined set point to the local resource controller 24 of the generator resource 16 (step 70).

The ancillary services controller 12 will execute the optimization program module 28 at a pre-determined time interval, such as every two seconds. Alternatively, the optimization program can be executed again when the completion time specified in the AGC signal 22 has elapsed. Alternatively, the ancillary services controller can execute the optimization program module 28 at more or less frequent intervals. For example, the ancillary services controller 12 can execute the optimization program module 28 every time there is a change in the AGC control signal 22.

In an alternative embodiment, the optimization program module 28 can be programmed to keep the generator 16 at or as close as possible to its optimally efficient set point, by using the load 18 to respond to the AGC signal whenever the AGC signal requires a response that would decrease the efficiency of the generator 16. This programming logic prioritizes optimizing generator efficiency, and can be particularly beneficial when the cost of using the load in this manner is not overly prohibitive.

The examples described below utilize such an alternative programming logic. The first example tries to use the generator whenever the AGC set point is more efficient than the current generator set point. The second example tries to use the generator whenever the change in AGC set point plus the current generator set point is more efficient than the current generator set point.

### Example 1

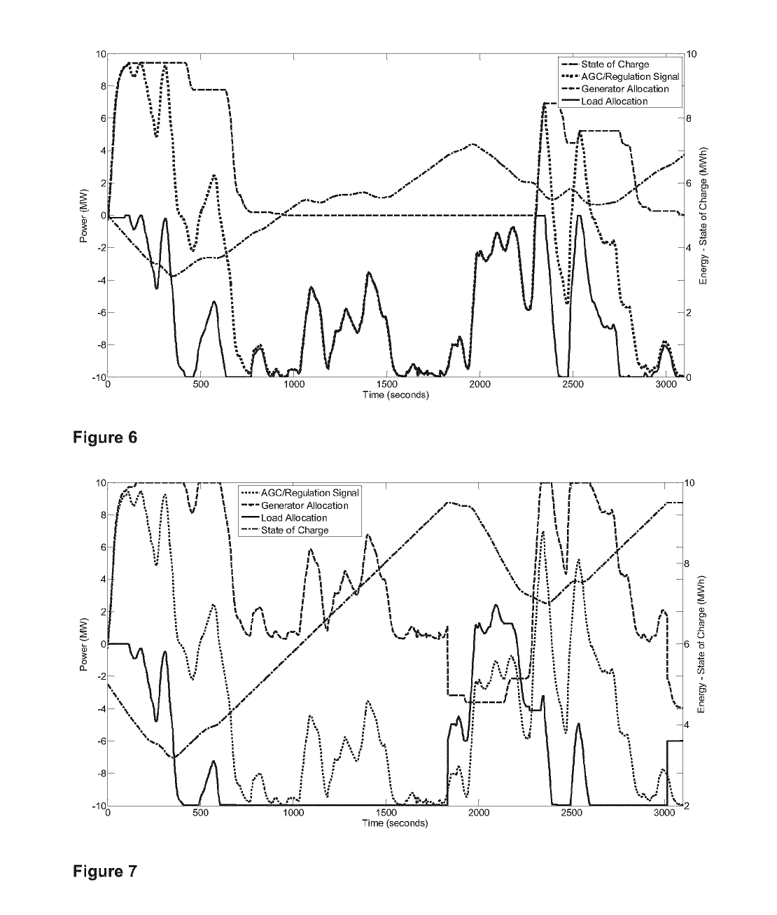

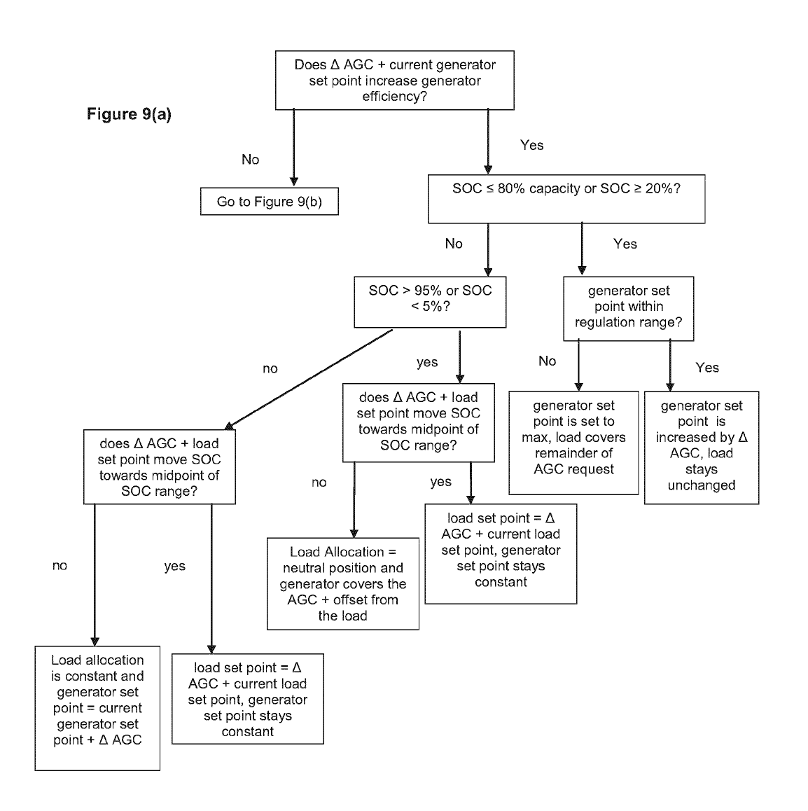

In this example and referring to FIGS. 6 and 8, a boiler is selected to be the load resource, a generator is provided with an efficiency curve as shown in FIG. 3, and an AGC request signal is in the form as shown in FIG. 4. The generator and the boiler each have an allocated regulation services range of +/−10 MW. The generator has a rated output of 110 MW and regulates around a base-point of 100 MW, i.e. is capable of increasing or decreasing power output by +/−10 MW; this regulation services range is calibrated against the generator's efficiency curve such that the base-point is at set point A, and +10 MW of regulation services is at set point C, which is just above its optimal set point B on the efficiency curve. The boiler system size is 25 MW and regulates around a base-point of 15 MW, i.e. is capable of increasing or decreasing power consumption by +/−10 MW. The boiler system water tank has thermal storage associated with it and can have an energy state of charge (“SOC”) between 0 MWh and 10 MWh. The natural heating demand of the municipality corresponds to a power set point of the boiler system of 9 MW (a regulation response set point of −6 MW) at which there is no impact to the water tank heat capacity SOC because the heat gets directly consumed by the municipality.

To elaborate, the boiler's primary process is to provide district heating to a municipality; the optimization program module calibrates the boiler's regulation services range such that at when the boiler is providing −6 MW of regulation services it is operating to maintain the heating demand at a constant temperature (“neutral position”) and there is no effect on the heat capacity of the boiler's water tank (i.e. the state of charge of the boiler). In other words, when the load response falls below −6 MW, the boiler is generating more heat (i.e. increasing consumption) than necessary to meet the natural heating demand and the state of charge increases; conversely, when the load response rises above −6 MW the boiler output is reduced below what is necessary to meet natural heat demand and retained heat in the boiler tank must be used to meet the balance of the natural heat demand, thereby causing the state of charge to drop.

The optimization program module's operational logic is shown in FIG. 8, and when executed generates a generator and load schedule as shown in FIG. 6. Subject to the availability of the load to provide regulation services, the operational logic essentially uses the generator to respond to an AGC request whenever the current AGC request (i.e. the AGC request signal shown in FIG. 6) presents a more efficient set point for the generator than at the current generator set point. When the current AGC request signal does not provide a more efficient set point for the generator, the operational logic will, subject to the availability of the load, keep the generator's set point at its current level and use the load to respond to the AGC request.

Notably, the optimization program module 28 will not allow the generator to respond to the AGC request when the load is not available to respond to at least some of the AGC request, i.e. when the SOC is not within its boundaries or when the load is not operating within its regulation services range. When the AGC request would increase the generator's efficiency (typically raising the generator's set point) but the load is at the limit of its regulation service range, the optimization program module 28 will keep the load set point constant and set the generator's set point to respond to both the AGC request and load offset. Similarly, when the AGC request would increase the generator's efficiency but the SOC is at one of its limits, the generator set point will be set to cover both the AGC request and the offset from the load. Conversely, when the AGC request does not provide a set point that increases the generator's efficiency over the current generator set point, but the load is at one of the limits of its regulation services range, the optimization program module 28 keeps the load set point constant at the limit and sets the generator's set point to cover the AGC request and load offset. Similarly, when the AGC request does not provide a set point that increases the generator's efficiency, but the SOC is at one of the limits, the optimization program module 28 will set the load set point at its neutral position and set the generator set point to cover the AGC request and the offset from the load.

As can be seen at T=0 seconds to T=about 400 seconds, the optimization program module 28 is able to keep the generator at or near its optimal set point of 95%. At T=0 seconds, the sum of the generator and load set points are equal to the AGC request of 0 MW of regulation services and the state of charge of the boiler tank is 5 MWh. From T=0 seconds to about T=200 seconds, the AGC signal requests an increase in regulation response to about 9.5 MW, and the optimization program module 28 allocates the entire requested increase to the generator in order to move its set point closer to the optimally efficient operational set point (Point B in FIG. 3). During this time the state of charge is increasing, as the boiler is at a set point of approximately 0 MW which is above the neutral power set point (−6 MW) that is equal to the natural heat demand of the municipality. At approximately T=200 seconds to approximately T=400 seconds, the AGC request signal fluctuates between +9.5 MW and −2.5 MW. The optimization program then selects the boiler to adjust its power consumption to match the AGC request signal, and keeps the generator operating at +9.5 MW. When the AGC request signal drops from 9.5 MW to about −2.5 MW, the boiler setpoint is decreased until −10 MW is reached, representing the lower limit of the boiler's regulation services range. Decreasing the boiler setpoint corresponds to increasing the boiler power consumption, and when the boiler setpoint drops below −6 MW, the thermal energy stored in the boiler tank begins to increase, thereby causing an increase of the boiler tank state of charge.

When the boiler setpoint reaches −10 MW the boiler is no longer able to provide further regulation services, and the optimization program module is programmed to use the generator to provide the balance of the response to the AGC request signal; at T=400 seconds, the optimization program lowers the generator setpoint to 7.5 MW such that the aggregate generator and boiler response provides the requested −2.5 MW of regulation services at this time.

At approximately T=400 seconds to approximately T=1700 seconds, the AGC request fluctuates between about +2.5 and −10; as the AGC request over this period does not provide a set point that is more efficient than the generator set point over this period, the optimization program tries to keep the generator set point constant and use the load to respond to AGC request, whenever possible. Since the boiler is operating for the most part at below −6 MW during this period of time (corresponding to increased power consumption), the state of charge continues to increase throughout this period (the boiler is operating at a level which exceeds the natural heating demand causing the tank heat level to rise). At around T=700 seconds, the boiler again reaches its lower regulation services limit of −10 MW and the optimization algorithm is forced to lower the generator set point to respond to the balance of the AGC request signal; from about T=750 seconds to T=1700 seconds, the generator set point is dropped to 0 MW, meaning that the generator output has returned to point A on the generator efficiency curve.

At about T=1900 seconds, the AGC request signal rises to about −2.5 MW. At this point the optimization program carries out a cost comparison function that evaluates the benefit of decreasing the boiler's state of charge and the generator's operational set point. In this case, the load 18 follows the AGC signal because the AGC signal does not improve the generator's efficiency. The state of charge will drop as the load set point is above the −6 MW neutral set point.

From T=2300 seconds to about T=2700 seconds, the generator set point rises during this period from 0 MW, to about 7.5 MW, until it drops again at around T=2400 seconds due to a sharp drop in the AGC request signal. During this time, the optimization program uses the boiler to respond to fluctuations in the AGC request signal, and in those occasions when the boiler setpoint drops below −6 MW, the state of charge will increase.

### Example 2

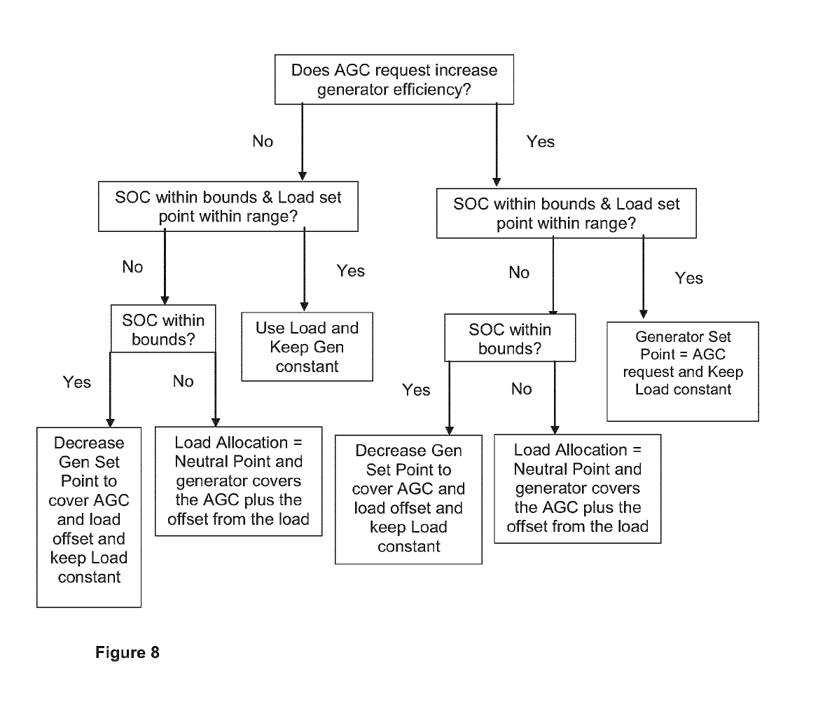

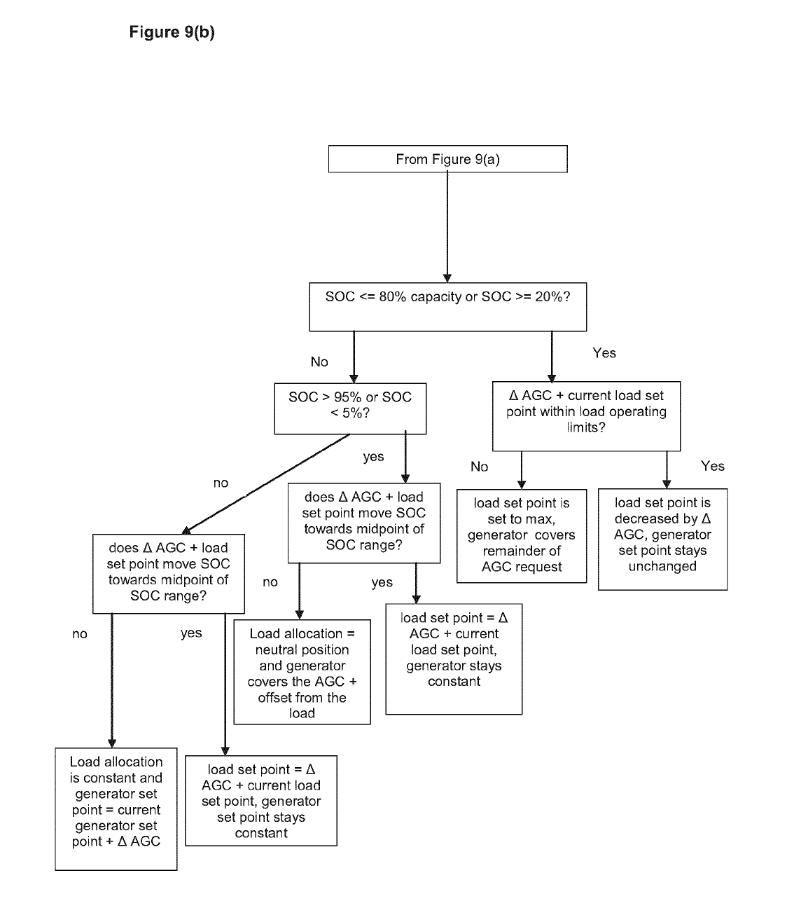

In this example and referring to FIGS. 7 and 9, the same generator and load parameters are used as in the first example. The primary difference between the two examples is the operational logic of the optimization program module 28. In this example, the optimization program module 28 is programmed to compare the costs of the current generator set point against the costs of a new generator set point that is the sum of the change in AGC request plus the current generator set point. If the change in regulation requested by the AGC signal+the current generator set point is more efficient than the current generator set point, then the optimization program module 28 will use the generator to respond to the AGC request, subject to the availability of the load to provide regulation services.

The optimization program module's operational logic is shown in FIGS. 9(a) and (b), and when executed generates a generator and load schedule as shown in FIG. 7. Subject to the availability of the load to provide regulation services, the operational logic essentially uses the generator to respond to an AGC request whenever the current change in AGC request+current generator set point presents a new set point for the generator that is more efficient than at the current generator set point. When the current AGC request does not provide a more efficient new set point for the generator, the operational logic will, subject to the availability of the load, keep the generator's set point at its current level and use the load to respond to the AGC request.

As can be seen in FIGS. 9(a) and (b), the availability of the load to provide regulation services depends on whether the state of charge is within specified boundaries and whether the load set point is within its regulation services range.

In this example, the optimization program module 28 has a two stage boundary for the state of charge: when the state of charge is greater than 80% or less than 20% of its range, the optimization program module will use the load to respond to the regulation request when doing so will move the state of charge back towards the midpoint of state of charge range; when the state of charge is greater than 95% or less than 5% of its range, the optimization program module 28 will set the load set point at its neutral position if responding to the AGC request will not move the state of charge towards the midpoint of the state of charge range. When the state of charge is outside of the 95%/5% band and the load set point is at its regulation services limit, the optimization program module 28 will move the generator set point to respond to the AGC request and move the state of charge back towards the midpoint of its range.

1. A method for providing automatic generation control (AGC) services comprising:
(a) allocating at least one generator resource and at least one load resource to provide AGC services; and
(b) responding to at least part of an AGC services request using the load resource such that the generation resource responds to the rest of the AGC services request by operating at an operating set point that is more efficient than a set point required for the generation resource to respond fully to the AGC services request.

2. A method as claimed in claim 1 wherein each load resource comprises an allocated state of charge range and an allocated AGC services range, and the at least one allocated load resources is operating at an operating set point within the allocated AGC services range and has a state of charge within the allocated state of charge range.

3. A method as claimed in claim 2 wherein each generation resource comprises an allocated AGC services range with a base set point that is different than an optimally efficient set point of the generation resource, and the operating set point of the at least one allocated generation resources is within the allocated AGC services range.

4. A method as claimed in claim 3 wherein the step of responding comprises executing a cost function comparing costs of using the load and generation resources to respond to the AGC services request at different load and generation set points and selecting a combination of load and generation set points that meets a cost effectiveness threshold.

5. A method as claimed in claim 4 wherein the costs of using the generation resource is a function of an efficiency profile of the generator resource.

6. A method as claimed in claim 4 wherein the costs of using the load resources is a function of a state of charge profile of the load resource.

7. A method as claimed in claim 6 wherein the costs of using the load resources is a function of an efficiency profile of the load resource.

8. A method as claimed in claim 4 wherein the cost of using the generation resource is always higher than the cost of using the load resource when the generation resource operating set point is less than the optimally efficient set point of the generation resource.

9. A method as claimed in claim 4 wherein the cost of using the load resource is always higher than the cost of using the generation resource when the state of charge of the load resource is at a maximum or minimum value in the allocated state of charge range.

10. A computer readable medium having encoded thereon instructions executable by a computer to carry out a method for providing automatic generation control (AGC) services, comprising:
(a) allocating at least one generator resource and at least one load resource to provide AGC services; and
(b) responding to at least part of an AGC services request using the load resource such that the generation resource responds to the rest of the AGC services request by operating at an operating set point that is more efficient than a set point required for the generation resource to respond fully to the AGC services request.

11. A system for providing automatic generation control (AGC) services comprising:
a processor communicative with at least one load resource and at least one generation resource to send set point control signals thereto and with a controller of a vertical integrated utility to receive an AGC services request signal therefrom;
a memory having encoded thereon instructions executable by the processor to carry out a method using the AGC request signal received by the processor, the method comprising
(a) allocating at least one generator resource and at least one load resource to provide AGC services; and
(b) responding to at least part of an AGC services request using the load resource such that the generation resource responds to the rest of the AGC services request by operating at an operating set point that is more efficient than a set point required for the generation resource to respond fully to the AGC services request.

12. A system as claimed in claim 11 wherein the processor is communicative with the at least one load resource and at least one generation resource to receive at least one of generator state information, load state information, generator efficiency profile, and load efficiency profile.

13. A computer readable medium as claimed in claim 10 wherein each load resource comprises an allocated state of charge range and an allocated AGC services range, and the at least one allocated load resources is operating at an operating set point within the allocated AGC services range and has a state of charge within the allocated state of charge range.

14. A computer readable medium as claimed in claim 13 wherein each generation resource comprises an allocated AGC services range with a base set point that is different than an optimally efficient set point of the generation resource, and the operating set point of the at least one allocated generation resources is within the allocated AGC services range.

15. A computer readable medium as claimed in claim 14 wherein the step of responding comprises executing a cost function comparing costs of using the load and generation resources to respond to the AGC services request at different load and generation set points and selecting a combination of load and generation set points that meets a cost effectiveness threshold.

16. A computer readable medium as claimed in claim 15 wherein the costs of using the generation resource is a function of an efficiency profile of the generator resource.

17. A computer readable medium as claimed in claim 15 wherein the costs of using the load resources is a function of a state of charge profile of the load resource.

18. A computer readable medium as claimed in claim 17 wherein the costs of using the load resources is a function of an efficiency profile of the load resource.

19. A computer readable medium as claimed in claim 15 wherein the cost of using the generation resource is always higher than the cost of using the load resource when the generation resource operating set point is less than the optimally efficient set point of the generation resource.

20. A computer readable medium as claimed in claim 15 wherein the cost of using the load resource is always higher than the cost of using the generation resource when the state of charge of the load resource is at a maximum or minimum value in the allocated state of charge range.

21. A system as claimed in claim 11 wherein each load resource comprises an allocated state of charge range and an allocated AGC services range, and the at least one allocated load resources is operating at an operating set point within the allocated AGC services range and has a state of charge within the allocated state of charge range.

22. A system as claimed in claim 21 wherein each generation resource comprises an allocated AGC services range with a base set point that is different than an optimally efficient set point of the generation resource, and the operating set point of the at least one allocated generation resources is within the allocated AGC services range.

23. A system as claimed in claim 22 wherein the step of responding comprises executing a cost function comparing costs of using the load and generation resources to respond to the AGC services request at different load and generation set points and selecting a combination of load and generation set points that meets a cost effectiveness threshold.

24. A system as claimed in claim 23 wherein the costs of using the generation resource is a function of an efficiency profile of the generator resource.

25. A system as claimed in claim 23 wherein the costs of using the load resources is a function of a state of charge profile of the load resource.

26. A system as claimed in claim 25 wherein the costs of using the load resources is a function of an efficiency profile of the load resource.

27. A system as claimed in claim 23 wherein the cost of using the generation resource is always higher than the cost of using the load resource when the generation resource operating set point is less than the optimally efficient set point of the generation resource.

28. A system as claimed in claim 23 wherein the cost of using the load resource is always higher than the cost of using the generation resource when the state of charge of the load resource is at a maximum or minimum value in the allocated state of charge range.
